(19) United States
(12) Patent Application Publication
(10) Pub. No.: US 2003/0086639 A1
(43) Pub. Date: May 8, 2003

(54) Bi-directional high-density optical switch

(75) Inventors: Peiching Ling, San Jose, CA (US); Jianjun Zhang, Cupertino, CA (US); Jinliang Chen, Saratoga, CA (US); Ming Xu, San Jose, CA (US); Lisa Tong, Sunyvale, CA (US)

Correspondence Address: Bo-In Lin, 13445 Mandoli Drive, Los Altos Hills, CA, 94022, US

(73) Assignee: Integrated Optics Communications Corp.

(21) Appl. No.: 10/291,457

(22) Filed: Nov. 7, 2002

Related U.S. Application Data
(60) Provisional application No. 60/337,620, filed on Nov. 8, 2001.

(51) Int. Cl. G02B 6/35

(52) U.S. Cl. 385/17; 385/18

(57) ABSTRACT

The present invention is a “bi-directional” high-density optical switch, which allows for size reduction of the optical switching matrix and the optical switching matrix package. Interlacing input and output channels and plurality of waveguides and 4 types of switching cells enable this high density optical switch to alternate the placement of the fiber guides on either side of the matrix substrate, leading to a significant overall reduction in the dimensions of the optical switching matrix.

This application claims priority to pending U.S. provisional patent application entitled BI-DIRECTIONAL HIGH-DENSITY OPTICAL SWITCH filed on Nov. 8, 2001 by Zhang et al. and accorded Serial No. 60/337,620, the benefit of its filing date being hereby claimed under Title 35 of the United States Code.

### BACKGROUND OF THE INVENTION

1. Field of the Invention

The present invention relates generally to a signal transmission system implemented with optical fibers and related optical components. More particularly, this invention relates to configuration and method to manufacture bi-directional high-density optical switches implemented in a dense wavelength division multiplexing (DWDM) system.

2. Description of the Related Art

Even though technologies in communication have made tremendous progress in the recent years, particularly in the manufacture of optical components with very high density, there are still limitations encountered by those of ordinary skill in the art to further increase the packaging density of a optical switch array. Specifically, there is a limitation due to the outer diameter of an optical fiber, typically 55 mills, and the minimal distance between adjacent waveguides must therefore maintain a minimum distance of about 55 mills. Meanwhile, as the high density packaging technology becomes more important because of more information as of today is being carried over optical communication networks, which allow information transport rate exceeding millions of bits per second. Increase in the packaging density enables a reduced cost of production, savings of space usage and often leads to components of higher performance and higher reliability.

In a U.S. Pat. No. 4,988,157 issued to Jackel et al., entitled “Optical Switch Using Bubbles”, an optical switch is disclosed. The switch constitutes a bistable cross-connect matrix. Parallel input waveguides and parallel output waveguides are formed on a substrate at perpendicular angles so as to intersect. A 45-degree slot is formed across each intersection and is filled with a fluid having a refractive index matching the waveguide material. Electrodes are positioned adjacent the slots and are selectively activated to electrolytically convert the fluid to gaseous bubbles, thereby destroying the index matching across the slot and causing light to be reflected by the slot rather than propagating across the slot. In the presence of a catalyst, a pulse of opposite polarity of sufficient size and of the same polarity will destroy the bubble. As illustrated in FIG. 1A, a 4×4 switch or cross-connect, a planar waveguide structure 10 is formed on a planar substrate 12. The waveguide structure 10 can be decomposed into four input waveguides 14 extending horizontally in the illustration and intersecting four output waveguides 16 extending vertically. Input optical fibers 18, 20, 22 and 24 are butt coupled to ends of the input waveguides 14. Output optical fibers 26, 28, 30 and 32 are likewise butt coupled to the output waveguides 16. Fiber guides 34 center the respective optical fibers 18 through 32 to the respective waveguides 14 and 16. In this switch array, the waveguides 14 and 16 could independently guide respective optical signals with minimum leakage or cross talk to the other waveguides 16 and 14. However, as explained above, when optical fibers are employed for waveguides 14 and 16, a minimum distance of 55 mills must be maintained, as the outer diameter of the optical fibers is 55 mills. Increase the packaging density of the switch array as that shown by Jackel et al. cannot be achieved with the configurations and method of manufactures disclosed in this prior art Patent. This limitation is illustrated in FIG. 1B that shows a conventional optical switch matrix with input waveguides 51, 52, 53, 54, and output waveguides 61, 62, 63, 64, where the distance between waveguide segments is ‘d’. The input fiber guides are designated A, B, C, D, and output fiber guides are designated E, F, G, H. A minimum distance between the waveguide is d, which is about 55 mills as limited by the outer diameter of the optical fibers.

Therefore, a need still exists in the art to provide an improved configuration and procedure for assembling and constructing a switch array to further reduce the minimum distance between the waveguides and to increase the packaging density.

### SUMMARY OF INVENTION

Briefly, in a preferred embodiment, the present invention discloses a “bi-directional” high density optical switch comprising a network of parallel input waveguide segments defined by N rows and parallel output waveguide segments defined by M columns intersecting at an intersection angle. An array of switch elements is placed at the intersections of input and output waveguide segments, forming a network of optical switching cells. The switch elements are configured to allow the passage of light in a transmissive state and to reflect light in a reflective state. The switching cells are defined into four types depending on the orientations of the normal lines with respect to the four Cartesian coordinate regions. A network of the four types of switching cells is configured in a specific alternating fashion into an optical switching matrix of N rows by M columns. The input and output fiber guides are placed into the optical switching matrix in an interlacing and “bi-directional” fashion, forming a high density optical switching matrix with up to 75% decrease in size. The optical switching matrix is configured onto an optical switching matrix package. The package is reduced up to 75% in size.

The present invention is also conceptualized as providing a method for constructing a “bi-directional” high density optical switch comprising the following steps: constructing a network of parallel input waveguide segments defined by N rows and parallel output waveguide segments defined by M columns intersecting at an intersection angle. A network of switch elements is constructed at the intersections of the input and output waveguide segments, forming a network of optical switching cells. The switch elements are configured to allow the passage of light in a transmissive state and to reflect light in a reflective state. The switching cells are constructed into four types depending on the orientations of their normal lines with respect to the four Cartesian coordinate quadrants. A network of the four types of switching cells is constructed in a specific alternating fashion into an optical switching matrix of N rows by M columns. The input and output fiber guides are constructed in the optical switching matrix in an interlacing and “bi-directional” fashion, forming a high density optical switching matrix with up to 75% decrease in size. The optical switching matrix is constructed onto an optical switching matrix package. The package is reduced up to 75% in size.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

The present invention can be better understood with reference to the following drawings. The components within the drawings are not necessarily to scale relative to each other, emphasis instead being placed upon clearly illustrating the principles of the present invention.

FIG. 1A and FIG. 1B are schematic views illustrating a conventional optical switch matrix;

FIG. 2 is a schematic view illustrating a “bi-directional” high-density optical switch matrix constructed in accordance with the present invention;

FIG. 3 is a schematic view illustrating a first type optical switching cell of FIG. 2 in a transmissive state;

FIG. 4. is a schematic view illustrating a first type optical switching cell of FIG. 2 in a reflective state;

FIG. 5 is a schematic view illustrating a second type optical switching cell of FIG. 2 in a transmissive state;

FIG. 6 is a schematic view illustrating a second type optical switching cell of FIG. 2 in a reflective state;

FIG. 7 is a schematic view illustrating a third type optical switching cell of FIG. 2 in a transmissive state;

FIG. 8 is a schematic view illustrating a third type optical switching cell of FIG. 2 in a reflective state;

FIG. 9 is a schematic view illustrating a fourth type optical switching cell of FIG. 2 in a transmissive e state; and

FIG. 10 is a schematic view illustrating a fourth type optical switching cell of FIG. 2 in a reflective state.

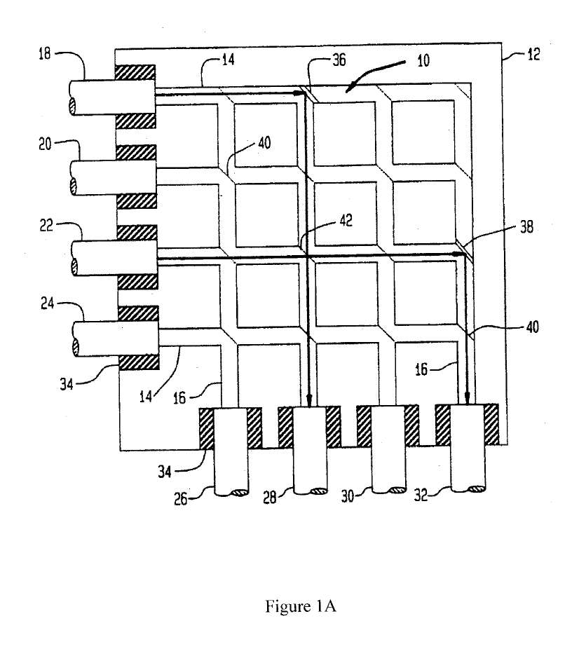

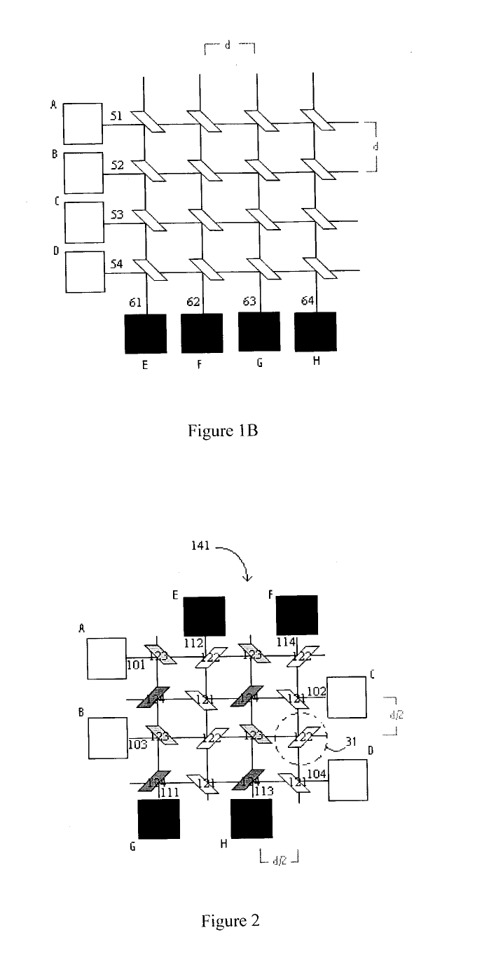

### DETAILED DESCRIPTION OF THE PREFERRED EMBODIMENT

FIG. 2 is functional block diagram illustrating a “bi-directional” high-density optical switch matrix with a network of interlacing first, second, third, fourth types optical switching cells 121, 122, 123, 124, where the placement of the input and output fiber guides are alternated “bi-directionally”. This allows the distance between the waveguides to be reduced up to d/2 since there are only 2 fiber guides on each side of the matrix. This is accomplished by alternating the input and output fiber guides “bi-directionally”. Each switch element 121, 122, 123, or 124 is located at the intersection of two waveguide segments. The combination of switch element 121, 122, 123, or 124 and the intersection of two waveguide segments forms an optical switching cell 31. A network of optical switching cells is thus formed by the association of switch element 121, 122, 123, or 124 with every intersection of waveguide segments in the optical switching matrix. An illustrative second type optical switching cell is illustrated within the dotted circle 31 and will be described in detail with respect to the remaining figures. Switch elements 121, 122, 123, and 124 are fabricated in accordance with the techniques disclosed in U.S. Pat. No. 4,988,157 to Jackel, et al., or the techniques disclosed in U.S. Pat. No. 5,699,462 to Fouquet, et al., which are hereby incorporated by reference. The operation of switch elements 121, 122, 123, 124 will be illustrated in the remaining figures. For the sake of brevity, the detail of construction of switch elements 121, 122, 123, 124 will not be provided here as it is already set out in full detail in the above-referenced U.S. Pat. No. 4,988,157 and U.S. Pat. No. 5,699,462.

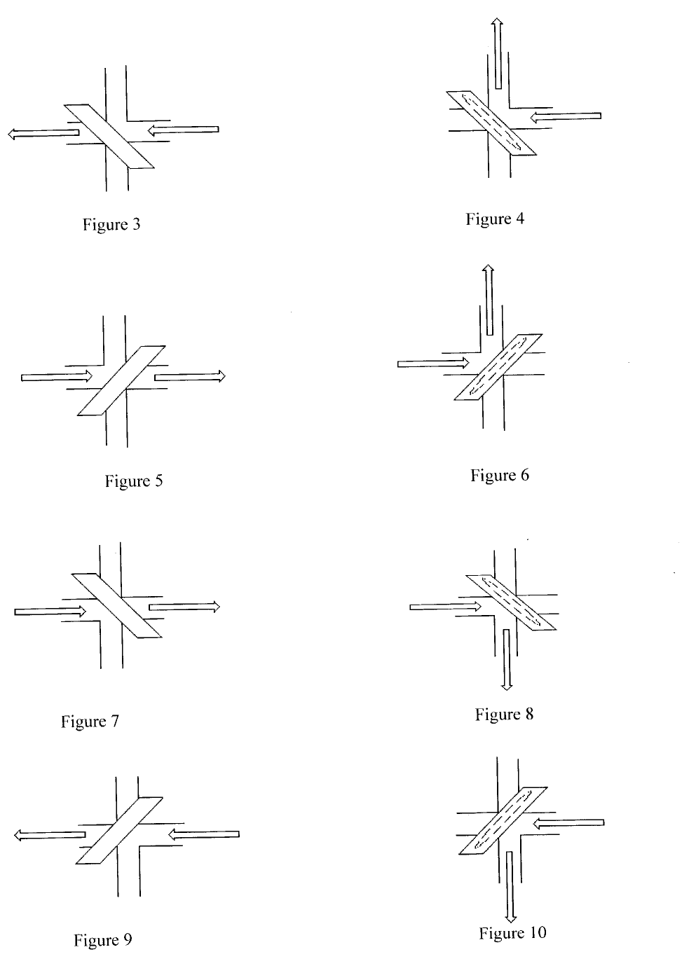

According to FIG. 2, the switch elements 121, 122, 123, 124 are arranged in a matrix formed by the intersection of input waveguides 101, 102, 103, 104 and output waveguides 111, 112, 113, 114, respectively. As illustrated as single lines, input waveguides 101, 102, 103, 104 and output waveguides 111, 112, 113, 114 are channels through which light travels. While illustrated as intersecting at right angles, input waveguides 101, 102, 103, 104 and output waveguides 111, 112, 113, 114 can intersect at angles other than right angles with the switching device properly adjusted to comply with the intersection angles. FIG. 2 is an example illustrated as a matrix 141 with four input waveguides and four output waveguides for a total of 16 optical switching cells. The optical switch matrix 141 may be comprised of any number of input waveguides and output waveguides, with a network of interlacing first, second, third, and fourth type switching cells situated at the intersection. As that shown in FIGS. 3 to 10, the switch elements 121, 122, 123, 124 are non-blocking when filled with an index matching medium because the switch elements 121, 122, 123, 124 will allow the transmission of light. On the other hand, when the switching elements change from a transmissive state to a reflecting state, the incident lights are reflected by the switching elements to different output waveguides.

According to the drawings and above descriptions, an optical device is disclosed in this invention. The optical device includes a first and a second sets of waveguides aligned respectively along a first and second directions wherein the first set of waveguides intersecting the second set of waveguides forming a plurality of waveguide intersections. The optical device further includes a plurality of optical switching means disposed on one of the waveguide intersections wherein each of the switching elements having transmission state for transmitting an optical signal therethrough and a reflection state for reflecting an optical signal to an intersecting waveguide therefrom. Every two adjacent optical switching means disposed at two adjacent waveguide intersections along each of the waveguides have a reflection state for reflecting an optical signal projected from a same optical input means toward two opposite directions through two adjacent output waveguides from the two adjacent optical switching means. The optical device thus forms a bi-directional optical transmission configuration. In another preferred embodiment, this invention discloses an optical device that includes a first and a second sets of waveguides aligned respectively along a first and second directions wherein the first set of waveguides intersecting the second set of waveguides forming a plurality of waveguide intersections. The optical device further includes a plurality of optical input/output means each connected to one of the first and second sets of waveguides wherein everyone two adjacent input/output means disposed near each other are connected to two non-adjacent waveguides.

According to above descriptions, a “bi-directional”, high-density optical switch is disclosed in this invention. The optical switch includes a network of parallel input waveguide segments and parallel output waveguide segments intersecting at a certain intersection angle. The input waveguide segments are defined by N rows, and M columns define the output waveguide segments. The intersection of any one input waveguide segment with one output waveguide segment defines four Cartesian coordinate quadrants, I, II, III, & IV. The input waveguide segments in one direction form a first side, and input waveguide segments in another direction form a second side. The output waveguide segments in one direction form a third side, and the output waveguide segments in another direction form a fourth side. The switch further includes a network of switch elements situated at the intersections of waveguide segments, wherein such switch elements are configured so as to allow the passage of light in a transmissive state and to reflect light in a reflective state. The intersections of the waveguide segments and the switch elements define an optical switching cell, wherein the placement of the switch element with its normal line bisecting Cartesian region I defines a first type optical switching cell. The placement of the switch element with its normal line bisecting Cartesian region II defines a second type optical switching cell. The placement of the switch element with its normal line bisecting Cartesian region III defines a third type optical switching cell. The placement of the switch element with its normal line bisecting Cartesian region IV defines a fourth type optical switching cell. The optical switch includes a plurality of the first, second, third, and fourth types switching cells configured in a matrix, the matrix comprising N rows by M columns, wherein the aforementioned optical switching matrix is configured into an optical switching matrix package. In a preferred embodiment, the arrangement of first type optical switching cell and fourth type optical switching cell occur in an alternating fashion on row N. In another preferred embodiment, the arrangement of second type optical switching cell and third type optical switching cell occur in an alternating fashion on row N. In another preferred embodiment, the arrangement of first type optical switching cell and second type optical switching cell occur in an alternating fashion on column M. In another preferred embodiment the arrangement of third type optical switching cell and fourth type optical switching cell occur in an alternating fashion on column M. In another preferred embodiment, the input fiber guides are arranged in an interlacing fashion on N rows. In another preferred embodiment, the input fiber guides are arranged in a “bi-directional” fashion on N rows. In another preferred embodiment, the input fiber guides are aligned with the first type optical switching cells on N rows on the first side. In another preferred embodiment, the input fiber guides are aligned with the third type optical switching cells on N rows on the second side. In another preferred embodiment, the output fiber guides are arranged in an interlacing fashion on M columns. In another preferred embodiment, the output fiber guides are arranged in a “bi-directional” fashion on M columns. In another preferred embodiment, the output fiber guides are aligned with the second type optical switching cells on M columns on the third side. In another preferred embodiment, the output fiber guides are aligned with the fourth type optical switching cells on the fourth side. In another preferred embodiment, the fiber-to-fiber spacing is decreased by up to ½ length-wise. In another preferred embodiment, the fiber-to-fiber spacing is decreased by up to ½ width-wise. In another preferred embodiment, the optical switching matrix size is decreased by up to 75%. In another preferred embodiment, the optical switching matrix package size is decreased by up to ½ length-wise. In anther preferred embodiment, the optical switching matrix package size is decreased by up to ½ width-wise. In another preferred embodiment, the optical switching matrix package size is decreased up to 75%. In another preferred embodiment, the optical switching matrix package V-grooves are arranged “bi-directionally”.

This invention further discloses a method for constructing a “bi-directional” high-density optical switch. The method includes the steps of A) constructing a network of parallel input waveguide segments and parallel output waveguide segments intersecting at an intersection angle with the input waveguide segments are defined by N rows and the output waveguide segments are defined by M columns, wherein the intersection of any one input waveguide segment with any one output waveguide segment define four Cartesian coordinate regions, I, II, III, and IV, wherein input waveguide segments in one direction form a first side, and input waveguide segments in another direction form a second side, and output waveguide segments in one direction form a third side, and output waveguide segments in another direction form a fourth side. B) Constructing a network of switch elements situated at the intersections of waveguide segments, wherein such switch elements are configured so as to allow the passage of light in a transmissive state and to reflect light in a reflective state, wherein the intersections of the waveguide segments and the switch elements define a optical switching cell. Placing the switch element with its normal line bisecting Cartesian region I to define a first type optical switching cell. And, C) Placing the switch element with its normal line bisecting Cartesian region II to define a second type optical switching cell. D) Placing the switch element with its normal line bisecting Cartesian region III to define a third type optical switching-cell. L) Placing the switch element with its normal line bisecting Cartesian region IV to define a fourth type optical switching-cell. And F) Configuring a plurality of the first, second, third and fourth types switching cells in a matrix, the matrix comprising N×M rows and columns, wherein the aforementioned optical switching matrix is configured into a optical switching matrix package.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1 An optical device comprising:
a set of input waveguides disposed substantially in parallel along a first direction wherein each of said input waveguides having a first end and a second end opposite said first end; and a set of output waveguides disposed substantially in parallel along a second direction wherein each of said output waveguides having a third end and fourth end opposite said third end;
each of said input waveguides intersected each of said output waveguides forming a plurality of waveguide intersections;
a plurality of optical input means each connected to one of said input waveguides through said first or said second ends; and a plurality of optical output means each connected to one of said output waveguides through said third or said fourth ends; and
a plurality of optical switching means disposed on one of said waveguide intersections wherein each of said switching elements having transmission state for transmitting an optical signal therethrough and a reflection state for reflecting an optical signal to an intersecting waveguide therefrom; and
every two adjacent optical switching means disposed at two adjacent waveguide intersections along each of said waveguides having a reflection state for reflecting an optical signal projected from a same optical input means toward two opposite directions through two adjacent output waveguides from said two adjacent optical switching means.

2. The optical device of claim 1 wherein:
said first direction is substantially perpendicular to said second direction.

3. The optical device of claim 1 wherein:
said optical switching means disposed at said waveguide intersection comprising a bubble switch for switching between a transmission state for transmitting an optical signal therethrough and a reflection state for reflecting an input optical signal from one of said input optical waveguides to one of said output optical waveguides.

4. The optical device of claim 3 wherein:
each of said optical switching means disposed at said waveguide intersection comprising a bubble switch disposed in a trench containing fluid with adjustable refraction index.

5. The optical device of claim 4 wherein:
every two adjacent optical switching means disposed at two adjacent waveguide intersections comprising a first bubble switch having a first trench and a second bubble switch with a second trench wherein said first and second trenches are configured to have different orientations.

6. The optical device of claim 4 wherein:
said first direction is substantially perpendicular to said second direction; and
every two adjacent optical switching means disposed at two adjacent waveguide intersections comprising a first bubble switch having a first trench and a second bubble switch with a second trench wherein said first and second trenches are configured to have orientations substantially perpendicular to each other.

7. The optical device of claim 1 wherein:
every two adjacent input means connected to a pair of nonadjacent input optical waveguides among said set of input waveguides and every two adjacent output means connected to a pair of non-adjacent output waveguides among said set of output waveguides.

8. The optical device of claim 1 wherein:
every two adjacent input means comprising two adjacent input optical fibers connected to a pair of non-adjacent input optical waveguides among said set of input waveguides and every two adjacent output means comprising two adjacent output optical fibers connected to a pair of non-adjacent output waveguides among said set of output waveguides.

9. The optical device of claim 6 wherein:
said first bubble switch of said adjacent switches having a first trench substantially having an incline angle of forty-five degrees relative to said first direction and said second trench having an orientation substantially perpendicular to said first trench.

10. An optical device comprising:
a set of input waveguides disposed substantially in parallel along a first direction wherein each of said input waveguides having a first end and a second end opposite said first end;
a set of output waveguides disposed substantially in parallel along a second direction wherein each of said output waveguides having a third end and fourth end opposite said third end;
each of said waveguides of said first set intersected each of said waveguides of said second set of waveguides forming a plurality of waveguide intersections;
a plurality of optical input means each connected to one of said input waveguides through said first or said second ends;
a plurality of optical output means each connected to one of said output waveguides through said third or said fourth ends; and
every two adjacent input means connected to a pair of nonadjacent input optical waveguides among said set of input waveguides and every two adjacent output means connected to a pair of non-adjacent output waveguides among said set of output waveguides.

11. The optical device of claim 1 wherein:
said first direction is substantially perpendicular to said second direction.

12. The optical device of claim 10 wherein:
a plurality of optical switching means disposed on one of said waveguide intersections wherein each of said switching elements having transmission state for transmitting an optical signal therethrough and a reflection state for reflecting an optical signal to an intersecting waveguide therefrom.

13. The optical device of claim 12 wherein:
every two adjacent optical switching means disposed at two adjacent waveguide intersections along each of said waveguides having a reflection state for reflecting an optical signal projected from a same optical input means toward two opposite directions through two adjacent output waveguides from said two adjacent optical switching means.

14. The optical device of claim 12 wherein:
said optical switching means disposed at said waveguide intersection comprising a bubble switch for switching between a transmission state for transmitting an optical signal therethrough and a reflection state for reflecting an input optical signal from one of said input optical waveguides to one of said output optical waveguides.

15. The optical device of claim 12 wherein:
each of said optical switching means disposed at said waveguide intersection comprising a bubble switch disposed in a trench containing fluid with adjustable refraction index.

16. The optical device of claim 15 wherein:
every two adjacent optical switching means disposed at two adjacent waveguide intersections comprising a first bubble switch having a first trench and a second bubble switch with a second trench wherein said first and second trenches are configured to have different orientations.

17. The optical device of claim 14 wherein:
said first direction is substantially perpendicular to said second direction; and
every two adjacent optical switching means disposed at two adjacent waveguide intersections comprising a first bubble switch having a first trench and a second bubble switch with a second trench wherein said first and second trenches are configured to have orientations substantially perpendicular to each other.

18. The optical device of claim 10 wherein:
every two of said adjacent input means comprising two adjacent input optical fibers connected to a pair of non-adjacent input optical waveguides among said set of input waveguides and every two of said adjacent output means comprising two adjacent output optical fibers connected to a pair of non-adjacent output waveguides among said set of output waveguides.

19. The optical device of claim 16 wherein:
said first bubble switch of said adjacent switches having a first trench substantially having an incline angle of forty-five degrees relative to said first direction and said second trench having an orientation substantially perpendicular to said first trench.

20. An optical device comprising:
a first and a second sets of waveguides aligned respectively along a first and a second directions wherein said first set of waveguides intersecting said second set of waveguides forming a plurality of waveguide intersections;
a plurality of optical switching means disposed on one of said waveguide intersections wherein each of said switching elements having transmission state for transmitting an optical signal therethrough and a reflection state for reflecting an optical signal to an intersecting waveguide therefrom; and
every two adjacent optical switching means disposed at two adjacent waveguide intersections along each of said waveguides having a reflection state for reflecting an optical signal projected from a same optical input means toward two opposite directions through two adjacent output waveguides from said two adjacent optical switching means.

21. An optical device comprising:
a first and a second sets of waveguides aligned respectively along a first and a second directions wherein said first set of waveguides intersecting said second set of waveguides forming a plurality of waveguide intersections;
a plurality of optical input/output means each connected to one of said first and second sets of waveguides wherein everyone two adjacent input/output means disposed near each other are connected to two non-adjacent waveguides.
